(19) United States
(12) Patent Application Publication
(10) Pub. No.: US 2014/0359112 A1
(43) Pub. Date: Dec. 4, 2014

(54) Burst Access to Memory in Optical Line Terminal

(71) Applicant: Broadcom Corporation, Irvine, CA (US)

(72) Inventors: Adiel Sarusi, Metar (IL); Yariv Aviram, Arad (IL); Assaf Koren, Netanya (IL)

(73) Assignee: Broadcom Corporation, Irvine, CA (US)

(21) Appl. No.: 14/021,943

(22) Filed: Sep. 9, 2013

Related U.S. Application Data
(60) Provisional application No. 61/829,762, filed on May 31, 2013.

(51) Int. Cl. H04L 12/26

(52) U.S. Cl. CPC H04L 43/0894
USPC 709/224

(57) ABSTRACT

The Optical line terminal (OLT) tracks the number of data packets, bandwidth per user, and other data packet statistics. DDR (DRAM) is used to store the information tracked by the OLT. The DDR is accessed in a burst mode. In particular, the data is initially stored in an on-chip cache memory and then the data is sent periodically to the DDR in a burst mode. Leaky buckets can be used for each flow, and time stamps can be used to determine the last time the bucket was accessed.

### CROSS REFERENCE TO RELATED APPLICATIONS

This patent application claims the benefit of U.S. Provisional Patent Application No. 61/829,762, filed May 31, 2013, entitled “BURST ACCESS TO MEMORY IN OPTICAL LINE TERMINAL,” which is incorporated herein by reference in its entirety.

### FIELD

This application relates generally to memory access, and more particularly to accessing memory utilizing a burst mode in an optical line terminal (OLT).

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates an exemplary optical network in accordance with an exemplary embodiment of the present disclosure.

FIG. 2 illustrates an exemplary optical line terminal in accordance with an exemplary embodiment of the present disclosure.

FIG. 3 illustrates a flowchart of a data packet processing method in accordance with an exemplary embodiment of the present disclosure.

The embodiments of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

Fiber to the x (FTTX) broadband network architectures include optical fiber in a portion or all of the broadband network. The optical fiber replaces all or part of the network typically implemented using electrical communication links that include, for example, metallic twisted pairs, coaxial cable, or the like. FTTX broadband network architectures include, for example, fiber-to-the-neighborhood/node (FTTN), fiber-to-the-curb/cabinet (FTTC), fiber-to-the-building (FTTB), fiber-to-the-premise (FTTP), fiber-to-the-home (FTTH), and fiber-to-the-desktop (FTTD). As the naming conventions suggest, the above examples represent network architectures with varying optical fiber deployment. That is, the various network architectures provide optical fiber access from a central office (CO) (e.g., internet service provider (ISP)) to a neighborhood, building, home, or the like.

Examples of optical fiber transmission systems that utilize the FTTX broadband network architectures include passive optical network (PON), such as Gigabit PON (GPON), Ethernet PON (EPON), and Active Ethernet, to provide some examples. Active Ethernet is a type of a FTTP network that uses optical Ethernet switches to distribute the signal, thus incorporating the customers' premises and the central office into a switched Ethernet network. As will be appreciated by those skilled in the relevant art(s), the broadband network architectures can also include Ethernet networks utilizing the Ethernet protocol (ISO/IEEE 802.3) and/or other networks utilizing one or more well-known fast packet switching protocols. That is, although the exemplary embodiments are described with references to passive optical networks (PON), the applications and operations of the various embodiments can be applied and/or implemented in any well-known network architecture as will be appreciated by those of ordinary skill in the relevant art(s).

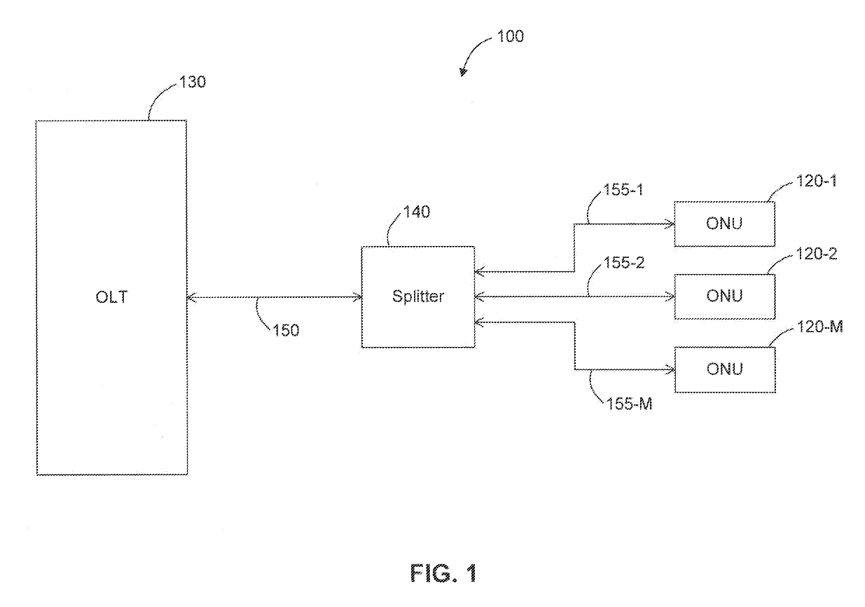

FIG. 1 illustrates a passive optical network (PON) 100 according an exemplary embodiment. The PON 100 includes M optical network units (ONUs) 120-1 through 120-M, coupled to an optical line terminal (OLT) 130 via a passive optical splitter 140. Traffic data transmission may be achieved by using two optical wavelengths, one for the downstream direction (e.g., 1490 nanometer (nm)) and another for the upstream direction (e.g., 1310 nm). Downstream transmission from the OLT 130 is broadcast to all ONUs 120. Each ONU 120 filters its respective data according to, for example, pre-assigned labels. ONUs 120 transmit respective data to OLT 130 during different time slots allocated by the OLT 130 for each ONU 120. Splitter 140 splits a single line 150 into multiple lines 155-1 through 155-M (e.g., lines 1 to 32, or, in the case of a longer distance from OLT 130 to ONUs 120, into lines 1 to 16).

Each of the ONUs 120 includes suitable logic, circuitry, and/or code that is configured to convert incoming optical signals from the OLT 130 into electrical signals, and outgoing electrical signals into optical signals that are then provided to the OLT 130. The splitter 140 includes suitable logic, circuitry, and/or code that is configured to split single line 150 into multiple lines 155-1 through 155-M in the upstream direction and combine the multiple lines 155-1 through 155-M into the single line 150 in the downstream direction. The OLT 130 includes suitable logic, circuitry, and/or code that is configured to convert incoming electrical signals from, for example, the service provider's equipment into optical signals that are then provided to the ONUs 120, and outgoing optical signals from the ONUs 120 to electrical signals. The OLT 130 is also configured to coordinate the multiplexing of data to/from the ONUs 120.

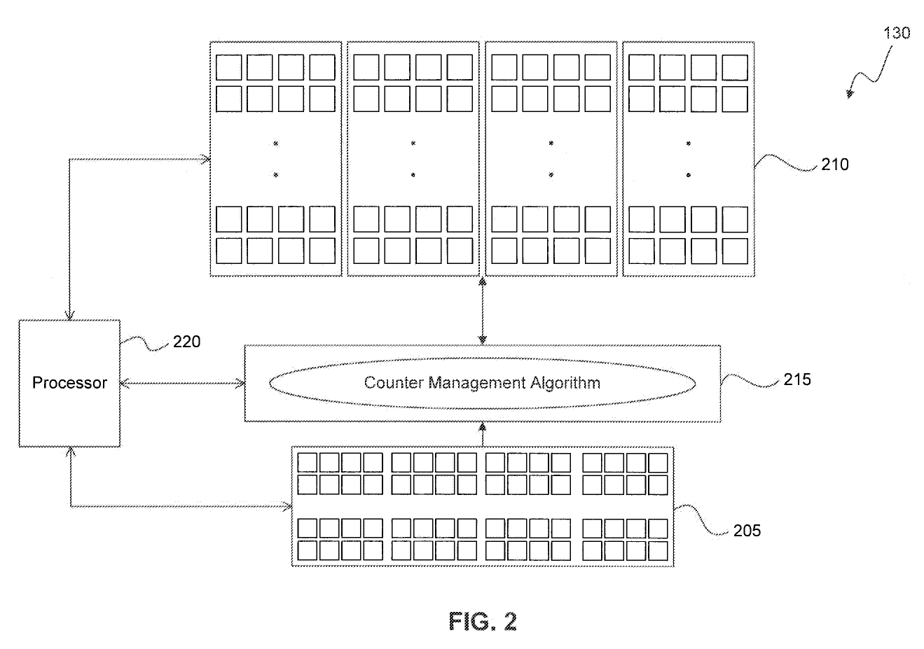

In an exemplary embodiment, and with reference to FIG. 2, the OLT 130 includes an on-chip memory unit 205, an off-chip memory unit 210, a memory controller 215, and a processor 220. The on-chip memory unit 205 can be, for example, static random-access memory (SRAM) and the off-chip memory unit 210 can be, for example, dynamic random-access memory (DRAM). The on-chip memory unit 205 and the off-chip memory unit 210 can be configured to store packet data and/or statistics. The packet statistics can be utilized by the OLT 130 to perform the traffic policing and/or shaping. In an exemplary embodiment, the DRAM can be a synchronous dynamic random-access memory (SDRAM). For example, the off-chip memory unit 210 can be a double data rate (DDR) SDRAM. The on-chip and off-chip memory units 205, 210 are not limited to the above examples, and the memory units 205, 210 can be any well-known memory as will be apparent to those skilled in the relevant art(s). In an exemplary embodiment, the off-chip memory unit 210 is a larger memory unit than the on-chip memory unit 205. Further, in exemplary embodiments utilizing leaky and/or token bucket algorithms, the on-chip memory unit 205 and/or the off-chip memory unit 210 can store the quantity of tokens with the token buckets. The on-chip memory unit 205 can also be configured to store a flag (ddr_empty) that indicates whether the off-chip memory unit 210 is empty. For example, if the ddr_empty flag has a value of 1, the OLT 130 can determine that the off-chip memory unit 210 does not contain any tokens within a token bucket stored within the off-chip memory unit 210 (i.e., the off-chip memory unit 210 is currently empty). If the ddr_empty flag has a value of 0, the OLT 130 can determine that the off-chip memory unit 210 has at least one token within token bucket stored within the off-chip memory unit 210.

The memory controller 215 includes suitable logic, circuitry, and/or code that is configured to control the overall operation of, and exchange of data between, the on-chip memory unit 205 and off-chip memory unit 210. That is, the memory controller 215 can be configured to perform the counter management algorithm shown in FIG. 2. The memory controller 215 can include one or more processors configured to perform the above operations, and the memory controller 215 can be communicatively coupled to the on-chip and off-chip memory units 205, 210.

The processor 220 includes suitable logic, circuitry, and/or code that is configured to control the overall operation and/or configuration of the OLT 130 and/or perform one or more basic arithmetical, logical, and input/output operations of the OLT 130. For example, and as discussed in more detail below, the processor 220 can be configured to perform monitoring of arriving data packets and/or token buckets, generate timestamps corresponding to packet arrival times, access the token buckets and/or memory units 205, 210, instruct the memory controller 215 to perform one or more operations, and/or to generate a periodic token addition value (PTA) to provide some examples. It will be appreciated by those skilled in the art that the various operations performed by the OLT 130 described herein can be performed by the processor 220, the memory controller 215, or a combination of the processor 220 and memory controller 215.

In an exemplary embodiment, and with reference to FIG. 2, the OLT 130 includes suitable logic, circuitry, and/or code that is configured to monitor data packet transmissions, bandwidth per user, and/or other data packet statistics, perform traffic policing and/or shaping, store and manage packet data and/or statistics in on-chip memory and/or off-chip memory, and control the communication between the on-chip memory and off-chip memory within the OLT 130. In an exemplary embodiment, the communication between the on-chip memory and the off-chip memory can be performed periodically using a burst mode.

In an exemplary embodiment, the monitoring of data packet transmissions, bandwidth per user, and/or other packet statistics, the performance of traffic policing and/or shaping, and/or the storage and management of packet data and/or statistics can utilize a counter management algorithm, which may include, for example, a leaky bucket and/or token bucket algorithm. For example, in a token bucket algorithm, a token can be added to the bucket at a predetermined rate, where the bucket can hold a predefined maximum number of tokens. If a token arrives when the bucket is full, the token is discarded. When a data packet of n bytes arrives, n tokens are removed from the bucket, and the data packet is transmitted (e.g., the data packet is conforming). If there are insufficient tokens in the bucket (e.g., the data packet is non-conforming), the data packet can be, for example, buffered until the bucket contains sufficient tokens, or the data packet can be discarded.

Similarly, in a leaky bucket algorithm, a token is taken out of the bucket at a predetermined rate (e.g., the tokens leak out of the bucket), where the bucket can hold a predefined maximum number of tokens. If there are no remaining tokens in the bucket (i.e., it is empty), no tokens are leaked from the bucket. When a data packet of n bytes arrives, n tokens are added to the bucket, and the data packet is transmitted (e.g., the data packet is conforming). If there is insufficient room in the bucket to add the n tokens (i.e., the addition would result in the bucket overflowing) the data packet can be considered non-conforming. Here, the data packet can be, for example, buffered until the bucket has sufficient capacity to accept the n tokens (e.g., enough time has elapsed that enough tokens have leaked out of the bucket), or the data packet can be discarded. For the purpose of this discussion, the description of the operation of the OLT 130 will be described with respect to a token bucket algorithm.

In operation, and with reference to FIG. 2, the OLT 130 (e.g., processor 220 and/or memory controller 215) is configured to monitor arriving data packets. Upon arrival of a data packet, the processor 220 is configured to perform traffic policing and/or shaping and to control the storage of packet related statistics within the on-chip memory unit 205 and/or the off-chip memory unit 210. For example, utilizing the leaky/token bucket algorithm, the processor 220 is configured to determine when packet related statistics are to be stored in the off-chip memory unit 210 (e.g., moved from the on-chip memory unit 205 to the off-chip memory unit 210) and/or if the data packet is to be transmitted. That is, the processor 220 can compare a number of available tokens stored in the on-chip memory unit 205 and/or the off-chip memory unit 210 with the size of the received data packet. Based on this comparison, the processor 220 can store the packet related statistic in the on-chip memory unit 205 and/or the off-chip memory unit 210, transmit the packet related statistics to the off-chip memory unit 210 and/or transmit the data packet upstream (e.g., to the ONUs 120) and/or downstream (e.g., to the internet service provider). For example, the processor 220 can be configured to control the memory controller 215 to perform the storage and/or transmission of packet related statistics. Here, the transmission of the packet related statistics is performed in a burst mode, thereby reducing the frequency at which the off-chip memory unit 210 is accessed. Burst mode can be, for example, the storage of packet related statistics in the on-chip memory unit 205, and the periodic transmission of a portion of the stored packet related statistics to the off-chip memory unit 210.

In performing the traffic policing and/or shaping, the processor 220 can be configured to monitor the arrival of data packets and control the memory controller 215 to access the on-chip memory unit 205 and the off-chip memory unit 210. Based on the monitoring, the processor 220 can determine timestamps corresponding to the arrival of respective data packets and to the times at which the memory units 205, 210 are accessed. For example, the OLT 130 (utilizing the processor 220) can extract timestamps from data packets upon and/or following arrival of the packets. In exemplary embodiments implementing a token/leaky bucket algorithm, the processor 220 can be configured to monitor the access to the bucket, and to generate timestamps corresponding to times in which the bucket(s) is accessed.

Utilizing the timestamps and a committed information rate (CIR), the processor 220 can be configured to generate a periodic token addition value (PTA) that corresponds to the amount of tokens that were to be added to a token bucket of a token/leaky algorithm over an elapsed time (e.g., the amount of tokens that were to be added during the duration of time since the token bucket was last accessed). Here, the CIR is a predetermined rate at which tokens are to be added to a token bucket (i.e., a token per unit of time). In determining the PTA, the processor 220 determines the time difference between a timestamp corresponding to the last time the token bucket has been accessed (t_{last access}) and a timestamp corresponding to the current time (t_{current}). Here, the current time can correspond to the arrival of the data packet at the OLT 130. That is, processor 220 determines the time elapsed since the token bucket was last accessed. The elapsed time is then multiplied by the CIR to determine the PTA. In an exemplary embodiment, the PTA, CIR and/or the various timestamps can be stored in the on-chip memory unit 205. The PTA is defined by the following equation:

PTA=CIR*(t_{current}−t_{last access})

The monitoring of incoming data packets can include determining the size (PS) of the received data packets. For example, the processor 220 can be configured to determine the size of the received data packets upon, or following, arrival of the packets. Following the determination of the size of the received data packet, the processor 220 can be configured to compare the data packet's size to the determined PTA and the token value at the time of last access to the token bucket. Based on this comparison, the processor 220 can be configured to determine if there are a sufficient number of tokens within the token bucket. For example, in an exemplary embodiment, the on-chip memory unit 205 can store the current PTA value and the quantity of the tokens within the token bucket (Sram_C). That is, the on-chip memory unit 205 can store the current PTA value and the number of tokens within the bucket at the last time the bucket was accessed (Sram_C) by the processor 220 and/or memory controller 215.

If the packet size (PS) is less than or equal to the sum of the PTA value and the number of tokens within the bucket at the time the bucket was last accessed (Sram_C), the processor 220 can then determine whether the off-chip memory unit 210 contains any tokens by determining the value of the ddr_empty flag. If the processor 220 determines that the off-chip memory unit 210 contains at least one token (e.g., ddr_empty=0), the processor 220 can update the number of stored tokens within the token bucket of the on-chip memory unit 205 and update packet related statistics. The updating of the number of stored tokens within the token bucket of the on-chip memory unit 205 can be defined as follows:

Sram_{—}C_{current}=Sram_{—}C_{last access}+PTA−PS

Following the updating, the processor 220 identifies the data packet as a conforming data packet which can then be transmitted by the OLT 130. In an exemplary embodiment, the updating can also include overflow processing. Overflow processing includes determining if the current number of stored tokens within the token bucket (i.e., Sram_C_{current}) exceeds the capacity of the on-chip memory unit 205 (e.g., Sramₘₐₓ). That is, the processor 220 can determine if an overflow has occurred. If the processor 220 determines that Sram_C_{current} is greater than the capacity of the on-chip memory unit 205 (i.e., Sram_C_{current}>Sram_Cₘₐₓ), the processor 220 can update the current number of stored tokens within the token bucket (i.e., Sram_C_{current}) to fill the on-chip memory unit 205 to its capacity (i.e., Sram_C_{current}=Sram_Cₘₐₓ). The tokens in excess of the capacity of the on-chip memory unit 205 can then be stored in the off-chip memory unit 210. Following the overflow processing, the off-chip memory unit 210 content flag (ddr_empty) can be updated to indicate that the off-chip memory unit 210 is not empty (e.g., ddr_empty=0) if any excess tokens have been stored in the off-chip memory unit 210.

If processor 220 determines that the off-chip memory unit 210 does not contain at least one token (e.g., ddr_empty=1), the processor 220 can compare the number of tokens within the on-chip memory unit 205 token bucket (i.e., Sram_C_{last access}+PTA) to a predetermined threshold value (C_min), where the threshold value (C_min) is a minimum number of tokens within the on-chip memory unit 205 token bucket. If the number of tokens within the on-chip memory unit 205 token bucket is greater than the threshold value (C_min), the processor 220 can update the number of stored tokens within the token bucket of the on-chip memory unit 205 and the packet related statistics as discussed above. The processor 220 can then identify the data packet as a conforming data packet that can then be transmitted by the OLT 130 as discussed above. Conversely, if the number of tokens within the on-chip memory unit 205 token bucket is less than or equal to the threshold value (C_min), the processor 220 can update the number of stored tokens within the token bucket of the on-chip memory unit 205 and the packet related statistics, and identify the data packet as a non-conforming data packet. Because the data packet has been defined as non-conforming, the updating can be defined as:

Sram_{—}C_{current}=Sram_{—}C_{last access}+PTA

Here, the data packet can be buffered until the data packet has conformed (e.g., until there are sufficient tokens within the bucket) or can be discarded/dropped due to its non-conforming status. If the data packet is buffered until conformity and subsequently transmitted by the OLT 130, the updating can take the packet size into consideration as described above (e.g., the updating can also subtract the packet size PS from the updated number of stored tokens).

During the monitoring of incoming data packets, if the processor 220 determines that the packet size (PS) is greater than the sum of the PTA value and the number of tokens within the bucket at the time the bucket was last accessed (Sram_C), the processor 220 can again determine whether the off-chip memory unit 210 contains any tokens by determining the value of the ddr_empty flag. If the processor 220 determines that the off-chip memory unit 210 does not contain at least one token (e.g., ddr_empty=1), the processor 220 can similarly update the number of stored tokens within the token bucket of the on-chip memory unit 205 and the packet related statistics (e.g., Sram_C_{current}=Sram_C_{last access}+PTA), and identify the data packet as a non-conforming data packet. If the processor 220 determines that the off-chip memory unit 210 contains at least one token (e.g., ddr_empty=0), the processor 220 can compare the packet size (PS) to the amount of tokens within the token buckets of both the on-chip memory unit 205 and the off-chip memory unit 210 as discussed in detail below.

In accessing the off-chip memory unit 210, the processor 220 can be configured to instruct the memory controller 215 to determine the number of tokens (DDR_C) within the token bucket of the off-chip memory unit 210. Alternatively, the processor 220 can access the off-chip memory unit 210 directly to obtain the token quantity of the off-chip memory unit 210. Following the determination of the number of tokens (DDR_C) within the token bucket of the off-chip memory unit 210, the processor 220 can be configured to compare the packet size (PS) to the sum of the token buckets of the on-chip memory unit 205 and the off-chip memory unit 210 and the PTA value (i.e., Sram_C_{last access}+DDR_C+PTA). Additionally, the processor 220 can compare the sum of the PTA value and the token buckets of the on-chip memory unit 205 and off-chip memory unit 210 to the threshold value (C_min). If the sum of the PTA value and the token buckets of the on-chip memory unit 205 and off-chip memory unit 210 is greater than both the packet size (PS) and the threshold value (C_min) (e.g., Sram_C_{last access}+DDR_C+PTA>PS and Sram_C_{last access}+DDR_C+PTA>C_min), the processor 220 can identify the data packet as a conforming data packet. Otherwise, the processor 220 can identify the data packet as a non-conforming data packet.

Following the identification of the data packet, the processor 220 can perform update processing that can include updating of the token bucket amounts (Sram_C and DDR_C), the packet related statistics, the timestamps, and/or the memory indicator flags to provide some examples. For example, the processor 220 can update the on-chip memory (Sram_C) to include the maximum number of available tokens from the current PTA value and the combined tokens within the on-chip memory unit 205 and the off-chip memory unit 210 less the number of tokens corresponding to the packet size. The updating can be defined as follows:

Sram_{—}C_{current}=Sram_{—}C_{last access}+PTA+DDR_{—}C−PS

Any tokens in excess of the capacity of the on-chip memory unit 205 can be stored in the off-chip memory unit 210. Following this update, the off-chip memory unit 210 content flag (ddr_empty) can be updated based on the storage status of the off-chip memory unit 210. For example, if there are one or more excess tokens stored in the off-chip memory unit 210, the ddr_empty flag can be set to a value of 0. If the off-chip memory unit 210 does not include any excess tokens (i.e., the off-chip memory unit 210 is empty), the ddr_empty flag can be set to a value of 1. The processor 220 can also be configured to update the packet related statistics in the on-chip memory unit 205 and/or off-chip memory unit 210 alone or in combination with the memory controller 215, and to update the timestamps based on the times the token bucket(s) was last accessed.

Following update processing, the OLT 130 can be configured to transmit the data packet based on the identification of the data packet (e.g., transmit if conforming, queue/drop if non-conforming) and repeat the data packet processing discussed above for one or more subsequent data packets received by the OLT 130.

In an exemplary embodiment, the traffic policing and/or shaping can include a bypass mode where the traffic policing and/or shaping is temporary suspended. During a bypass mode, the processor 220 allows packets to flow through the system without performing traffic policing and/or shaping, and updates the number of stored tokens within the token bucket of the on-chip memory unit 205 based on the periodic token addition value (PTA) for each passing packet. If number of stored tokens within the token bucket exceeds the capacity of the on-chip memory unit 205 (e.g., an overflow has occurred), the processor 220 performs overflow processing that includes updating the number of stored tokens within the token bucket to fill the on-chip memory unit 205 to its capacity and storing any excess tokens in the off-chip memory unit 210. If any excess tokens have been stored in the off-chip memory unit 210, the off-chip memory unit 210 content flag (ddr_empty) can be updated accordingly (e.g., ddr_empty=0).

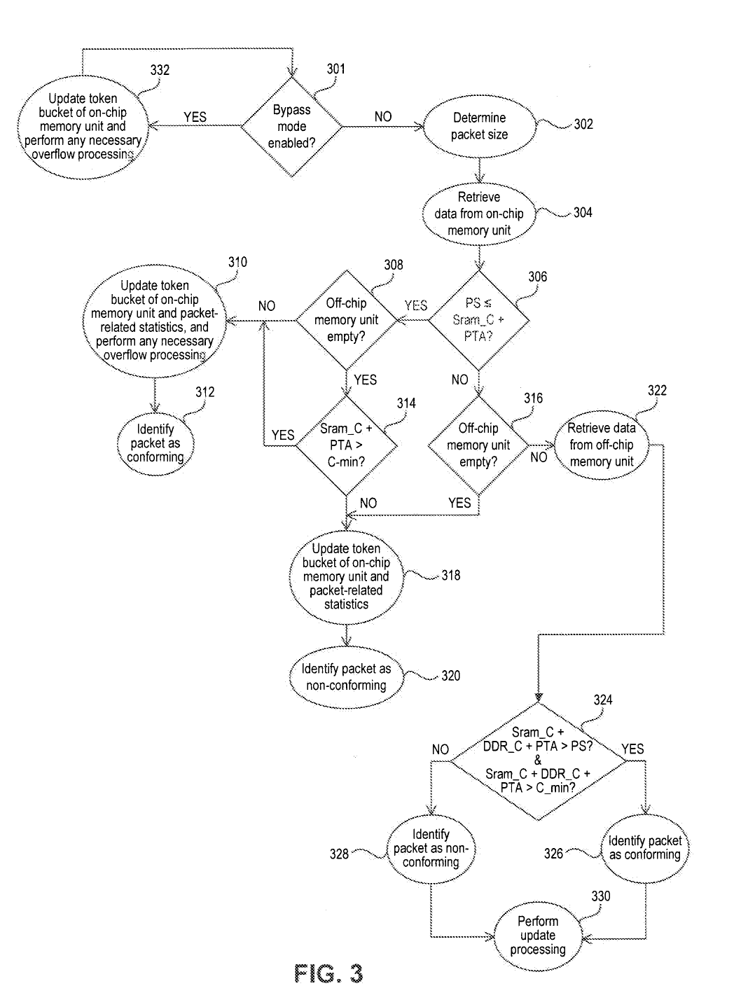

FIG. 3 illustrates a flowchart 300 of a data packet processing method in accordance with an exemplary embodiment of the present disclosure. The method of flowchart 300 is described with continued reference to FIGS. 1 and 2. The steps of the method of flowchart 300 are not limited to the order described below, and the various steps may be performed in a different order. Further, two or more steps of the method of flowchart 300 may be performed simultaneously with each other.

The method of flowchart 300 begins at step 301, where the OLT 130 determines if the bypass mode is enabled. If the bypass mode is enabled (YES at step 301), the flowchart 300 transitions to step 322, where the processor 220 updates the number of stored tokens within the token bucket of the on-chip memory unit 205. Further, the processor 220 can perform overflow processing if the number of stored tokens within the token bucket exceeds the capacity of the on-chip memory unit 205. (e.g., store excess in off-chip memory unit 210 and update content flag). Following the update (and any overflow processing), the flowchart returns to step 301.

If the bypass mode is disabled (NO at step 301), the flowchart 300 transitions to step 302, where the OLT 130 determines a packet size of a received data packet. For example, the processor 220 can be configured to determine the size of the received data packet upon, or following, arrival of the data packet.

After step 302, the flowchart 300 transitions to step 304, where the OLT 130 requests data from the on-chip memory unit 205. For example, the processor 220 and/or the memory controller 215 can retrieve the number of tokens stored in the on-chip memory unit 205 (e.g., Sram_C) and the timestamp corresponding to the last time the on-chip memory unit 215 was accessed.

After step 304, the flowchart 300 transitions to step 306, where the OLT 130 compares the size of the received data packet to the sum of the periodic token addition (PTA) value and the amount of tokens (Sram_C) within the token bucket of the on-chip memory unit 215 at the last time the token bucket was accessed. For example, the processor 220 can compare the sum of Sram_C and the PTA value to the packet size (PS).

If the size of the received packet (PS) is less than or equal to the sum of the amount of tokens (Sram_C) within the token bucket of the on-chip memory unit 215 and the PTA value (PS≦Sram_C_{last access}+PTA) (YES at step 306), the flowchart 300 transitions to step 308 where the OLT 130 determines if the off-chip memory unit 210 contains one or more tokens (i.e., whether the off-chip memory unit 210 is empty) based on the content flag ddr_empty.

If the processor 220 determines that the off-chip memory unit 210 is not empty (e.g., ddr_empty=0) (NO at step 308), the flowchart 300 transitions to step 310, where the processor 220 updates the number of stored tokens within the token bucket of the on-chip memory unit 205 and updates packet related statistics. If the number of stored tokens within the token bucket of the on-chip memory unit 205 exceeds the capacity of the on-chip memory unit 205, any excess tokens are stored in the off-chip memory unit 210 and the off-chip memory content flag (ddr_empty) is updated accordingly. Following step 310, the flowchart 300 transitions to step 312, where the processor 220 identifies the data packet as a conforming data packet which can then be transmitted by the OLT 130.

If the processor 220 determines that the off-chip memory unit 210 is empty (e.g., ddr_empty=1) (YES at step 308), the flowchart 300 transitions to step 314, where the processor 220 compares the number of tokens within the token bucket of the on-chip memory unit 205 (i.e., Sram_C_{last access}+PTA) to a predetermined threshold value (C_min), where the threshold value (C_min) is a minimum number of tokens within the on-chip memory unit 205 token bucket. If the number of tokens within the token bucket of on-chip memory unit 205 is greater than the threshold value (C_min) (e.g., Sram_C_{last access}+PTA>C_min) (YES at step 314), the flowchart 300 transitions to step 310. If the number of tokens within the token bucket of on-chip memory unit 205 is less than or equal to the threshold value (C_min) (e.g., Sram_C_{last access}+PTA≦C_min) (NO at step 314), the flowchart 300 transitions to step 318, where the processor 220 updates the number of stored tokens within the token bucket of the on-chip memory unit 205 and updates packet related statistics. Following step 318, the flowchart 300 transitions to step 320, where the processor 220 identifies the data packet as a non-conforming data packet. Here, the non-conforming data packet can be buffered until the data packet has conformed (e.g., until there are sufficient tokens within the bucket) or discarded/dropped.

At step 306, if the size of the received packet (PS) is greater than the sum of the amount of tokens (Sram_C) within the token bucket of the on-chip memory unit 215 and the PTA value (PS>Sram_C_{last access}+PTA) (NO at step 306), the flowchart 300 transitions to step 316, where the OLT 130 determines if the off-chip memory unit 210 contains one or tokens (i.e., whether the off-chip memory unit 210 empty) based on the content flag ddr_empty.

If the processor 220 determines that the off-chip memory unit 210 is empty (e.g., ddr_empty=1) (YES at step 316), the flowchart 300 transitions to step 318. Otherwise, if the processor 220 determines that the off-chip memory unit 210 is not empty (e.g., ddr_empty=0) (NO at step 316), the flowchart 300 transitions to step 322, where the processor 220 accesses the off-chip memory unit 210 and requests packet related statistics and/or other data. For example, the processor 220 can be configured to instruct the memory controller 215 to determine the number of tokens (DDR_C) within the token bucket of the off-chip memory unit 210. Alternatively, the processor 220 can access the off-chip memory unit 210 directly to obtain the token quantity of the off-chip memory unit 210.

After step 322, the flowchart transitions to step 324, where the processor 220 can perform two comparisons. For example, the processor 220 can compare the packet size (PS) to the sum of the PTA value and the token buckets of the on-chip memory unit 205 and off-chip memory unit 210 (i.e., Sram_C_{last access}+DDR_C+PTA). Additionally, the processor 220 can compare the sum of the PTA value and the token buckets of the on-chip memory unit 205 and off-chip memory unit 210 to the threshold value (C_min). If the sum of the PTA value and the token buckets of the on-chip memory unit 205 and off-chip memory unit 210 is greater than both the packet size (PS) and the threshold value (C_min) (e.g., Sram_C_{last access}+DDR_C+PTA>PS and Sram_C_{last access}+DDR_C+PTA>C_min) (YES at step 324), the flowchart 300 transitions to step 326, where the processor 220 can identify the data packet as a conforming data packet. Otherwise (NO at step 324), the flowchart transitions to step 328, where the processor 220 can identify the data packet as a non-conforming data packet.

After step 326 or 328, the flowchart 300 transitions to step 330, where the processor 220 can perform update processing. For example, the processor 220 can update the on-chip memory (Sram_C) to include the maximum number of available tokens from the current PTA value and the combined tokens within the on-chip memory unit 205 and off-chip memory unit 210 (e.g., Sram_C_{last access}+DDR_{C}+PTA). If the data packet is identified as conforming (YES at step 324) and subsequently transmitted, or subsequently transmitted following being buffered, the updating can also subtract the number of tokens corresponding to the packet size (PS) (e.g., Sram_C_{last access}+DDR_{C}+PTA−PS). Any tokens in excess of the capacity of the on-chip memory unit 205 can be stored in the off-chip memory unit 210. Following this update, the off-chip memory unit 210 content flag (ddr_empty) can be set accordingly. The processor 220 can also be configured to update the packet related statistics in the on-chip memory unit 205 and/or off-chip memory unit 210 alone or in combination with the memory controller 215, and update the timestamps based on the times the token bucket(s) was last accessed. Following the update processing, the OLT 130 can transmit the data packet based on the identification of the data packet (e.g., transmit if conforming or buffer/drop if non-conforming).

After step 330, the flowchart 300 can return to step 302 for processing of subsequent data packets received by the OLT 130.

### CONCLUSION

The aforementioned description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the specification is not meant to limit the invention. Rather, the scope of the invention is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventors, and thus, are not intended to limit the present invention and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

What is claimed is:

1. A data packet processing method, comprising:
retrieving a first stored token value from a first memory unit in response to a received data packet;
determining a token addition value based on a token rate value and an amount of time elapsed since reception of a preceding data packet;
determining a current token value based on the first stored token value and the token addition value;
determining a storage status of a second memory unit based on data retrieved from the first memory unit; and
retrieving a second stored token value from the second memory unit based on the storage status of the second memory and a comparison of the packet size of the received data packet and the current token value.

2. The data packet processing method of claim 1, comprising:
updating the first stored token value based on the comparison of the packet size of the received data packet with the current token value, and on the storage status of the second memory unit.

3. The data packet processing method of claim 2, wherein the updating includes setting the first stored token value as a difference between the current token value and the packet size of the received data packet.

4. The data packet processing method of claim 2, wherein the updating includes setting the first stored token value as the current token value or setting the first stored token value as a difference between the current token value and the packet size of the received data packet; and
wherein the updating of the first stored token value is further based a comparison of the current token value to a predetermined token threshold value.

5. The packet processing method of claim 1, further comprising:
updating the first stored token value and the second stored token value based on a comparison of a sum of the second stored token value and the current token value to each of the packet size of the received data packet and a predetermined token threshold value.

6. The data packet processing method of claim 1, wherein the updating of the first stored token value includes setting the first token value as a difference between (1) the sum of the second stored token value and the current token value and (2) the packet size of the received data packet; and wherein the updating of the second stored token value includes setting the second stored token value as a number of tokens in excess of a maximum token value of the first memory unit if the difference exceeds the maximum token value.

7. The data packet processing method of claim 6, further comprising:
updating the storage status of the second memory unit based on the updating of the second stored token value, wherein the storage status of the second memory unit is updated to indicate that the second memory unit contains at least one token if the difference exceeds the maximum token value, and is updated to indicate that the second memory unit contains zero tokens if the difference is less than or equal to the maximum token value.

8. The data packet processing method of claim 1, wherein the token addition value is an amount of tokens to be added to the first stored token value since reception of the preceding data packet.

9. The data packet processing method of claim 1, wherein the token rate value is a predetermined value representing an amount of tokens to be added to the first token value per unit of time.

10. The data packet processing method of claim 1, wherein the first memory unit is an on-chip memory unit and the second memory unit is an off-chip memory unit.

11. An optical line terminal (OLT), comprising:
a first memory unit configured to store a first stored token value;
a second memory unit configured to store a second stored token value; and
a processor configured to:
retrieve the first stored token value from the first memory unit in response to a data packet being received by the OLT;
determine a token addition value based on a token rate value and an amount of time elapsed since reception of a preceding data packet;
determine a current token value based on the first stored token value and the token addition value;
determine a storage status of a second memory unit based on data retrieved from the first memory unit; and
retrieve a second stored token value from the second memory unit based on the storage status of the second memory and a comparison of the packet size of the received data packet and the current token value.

12. The OLT of claim 11, wherein the processor is further configured to:
update the first stored token value based on the comparison of the packet size of the received data packet and the current token value, and on the storage status of the second memory unit.

13. The OLT of claim 12, wherein the processor is further configured to update the first stored token value by setting the first stored token value as a difference between the current token value and the packet size of the received data packet.

14. The OLT of claim 12, wherein the processor is configured to compare the current token value to a predetermined token threshold value, wherein the updating of the first token value is further based on the comparison.

15. The OLT of claim 14, wherein the processor is further configured to update the first stored token value by setting the first stored token value as the current token value or setting the first stored token value as a difference between the current token value and the packet size of the received data packet.

16. The OLT of claim 11, wherein the processor is further configured to update the first stored token value and the second stored token value based on a comparison of a sum of the second stored token value and the current token value to each of the packet size of the received data packet and a predetermined token threshold value.

17. The OLT of claim 16, wherein the processor is further configured to update the first stored token value by setting the first token value as a difference between (1) the sum of the second stored token value and the current token value and (2) the packet size of the received data packet.

18. The OLT of claim 18, wherein the processor is further configured to update the second stored token value by setting the second stored token value as a number of tokens in excess of a maximum token value of the first memory unit if the difference exceeds the maximum token value.

19. The OLT of claim 18, wherein the processor is further configured to update the storage status of the second memory unit based on the updating of the second stored token value, wherein the storage status of the second memory unit is updated to indicate that the second memory unit contains at least one token if the difference exceeds the maximum token value, and updated to indicate that the second memory unit contains zero tokens if the difference is less than or equal to the maximum token value.

20. A data packet processing method, comprising:
receiving a data packet;
determining a packet size of the received data packet;
determining an off-chip token value associated with an off-chip memory if the packet size is greater than an on-chip token value associated with an on-chip memory and data stored in the on-chip memory indicates that the off-chip memory includes at least one token;
updating the on-chip token value to a difference between (1) a sum of the on-chip token value and the off-chip token value and (2) a token value corresponding to the packet size of the received data packet, wherein the on-chip token value is not to exceed a predetermined maximum token value; and
updating the off-chip token value to a number of tokens in excess of the predetermined maximum token value if the difference exceeds the predetermined maximum.
